(19) United States
(12) Patent Application Publication
(10) Pub. No.: US 2025/0000292 A1
(43) Pub. Date: Jan. 2, 2025

(54) JUICER ASSEMBLY

(71) Applicant: Crusher Hitch, LLC, Wilmington, DE (US)

(72) Inventors: James J. Freebery, Avondale, PA (US); James Maddox, Hockessin, DE (US); Basil S. Krikelis, Landenberg, PA (US); Jay Freebery, Wilmington, DE (US)

(73) Assignee: Crusher Hitch, LLC, Wilmington, DE (US)

(21) Appl. No.: 18/748,928

(22) Filed: Jun. 20, 2024

Related U.S. Application Data
(60) Provisional application No. 63/511,034, filed on Jun. 29, 2023.
(60) Provisional application No. 63/569,872, filed on Mar. 26, 2024.

(51) Int. Cl. A47J 19/02; B60N 3/10; B60R 9/06

(52) U.S. Cl. CPC A47J 19/023; B60N 3/103; B60R 9/06

(57) ABSTRACT

An example juicer assembly is provided. The juicer assembly includes a support tray. a juicer on the support tray, and a support assembly coupled to the support tray. One end of the support assembly is configured to engage with a structure for mounting of the juicer assembly to the structure.

### CROSS-REFERENCE TO RELATED APPLICATIONS

This application claims the benefit of a co-pending, commonly assigned U.S. Provisional Patent Application No. 63/511,034, which was filed on Jun. 29, 2023, and U.S. Provisional Patent Application No. 63/569,872, which was filed on Mar. 26, 2024, the foregoing applications are incorporated herein by reference in their entirety.

### BACKGROUND

Juicers can be used to create juice out of a variety of citrus fruits. In general, manual juicers are designed to be positioned on a kitchen countertop for use. In some instances, use of a juicer outside of the house may be desired, such as during tailgating events to make a variety of drinks. In such instances, transporting the bulky juicer to the desired location and finding a stable area to position the juicer can be problematic.

### SUMMARY

Embodiments of the present disclosure provide a juicer assembly including a juicer mounted to a support tray which, in turn, is mounted to a support assembly configured to be detachably secured to a car hitch. The juicer assembly allows for convenient transport of the juicer to any location, and maintains the juicer on a stable platform for use. The support tray includes various features to simplify use of the juicer and to provide room for accessories and/or fruit. The juicer assembly includes customization features in the support assembly to allow for adjustment of various angles of the juicer and/or support tray relative to horizontal, allowing the user to level the juicer assembly prior to use. The juicer assembly includes removable accessories to support a variety of items, such as, e.g., bottles, cups, ice, or the like. The juicer assembly includes a support tray with a raised edge along sides and rear perimeter edges, or a railing, to prevent items from rolling or falling off of the edge of the support tray. The juicer assembly includes swivel or angle adjustment features that allow the support tray to pivot relative to a support post in various directions, thereby providing clearance for a door of the vehicle or for storage purposes.

In accordance with embodiments of the present disclosure, an exemplary juicer assembly is provided. The juicer assembly includes a support tray, a juicer mounted to the support tray, and a support assembly coupled to the support tray. One end of the support assembly is configured to engage with a hitch of a vehicle for mounting of the juicer assembly to the hitch.

The support tray includes a top surface defining a flat surface. In some embodiments, the support tray can include drainage holes formed in a top surface for drainage of liquid from the top surface. In some embodiments, the support tray can include a raised edge along side and rear perimeter walls, the raised edge extending vertically above a plane defined by a top surface of the support tray. In some embodiments, the support tray can include a raised edge along the entire perimeter wall.

The juicer can include a base mounted to the support tray, a post, a press tray mounted to the post, a connector coupled to a top of the post, a handle pivotably coupled to the connector, and a press cap configured to move up and down relative to the press dray during pivoting of the handle. In some embodiments, the handle can include a groove formed therein. The juicer assembly can include an elastic strap connected at a first end to the support tray and including a loop at an opposing second end. The loop is configured to engage with the groove formed in the handle to lock the handle in a downward position. In some embodiments, at least a portion of the support tray can be magnetized.

The support assembly includes a mounting tube coupled at one end to a first end of a vertical support tube, the support assembly including a horizontal support tube coupled to a second end of the vertical support tube. The mounting tube can include holes and the support tray can include mounting flanges extending from a bottom surface of the support tray. The mounting flanges are spaced to receive at least a portion of the mounting tube therebetween. The mounting flanges includes holes configured to align with the holes of the mounting tube, and further configured to receive bolts therethrough for coupling of the mounting tube to the mounting flanges. One end of the horizontal support tube includes holes configured to engage with the hitch of the vehicle.

In some embodiments, a joint between the mounting tube and the vertical support tube can include a first adjustment mechanism configured to vary an angle between the mounting tube and the vertical support tube. In some embodiments, a joint between the vertical support tube and the horizontal support tube can include a second adjustment mechanism configured to vary an angle between the vertical support tube and the horizontal support tube. The angle between the mounting tube and the vertical support tube, and the angle between the vertical support tube and the horizontal support tube, are perpendicular to each other.

In some embodiments, the juicer assembly can include balancing feature disposed at a front face of the vertical support tube. The balancing feature includes a flat bottom surface substantially aligned with a bottom surface of the horizontal support tube. The bottom surface is configured to abut against the ground and prevent the juicer assembly from rotating when disconnected from the hitch.

In some embodiments, the support assembly can include multiple holes configured to engage with an attachment mechanism of the hitch. The multiple holes provide variability in a distance of the support tray relative to the vehicle. In some embodiments, the support tray can include multiple slots formed along a perimeter of the support tray. Pairs of the multiple slots are configured to receive complementary extensions of an accessory for detachably securing the accessory to the support tray.

In accordance with embodiments of the present disclosure, an exemplary juicer assembly is provided. The juicer assembly includes a support tray, a juicer on the support tray, and a support assembly coupled to the support tray. One end of the support assembly is configured to engage with a hitch of a vehicle for mounting of the juicer assembly to the hitch.

The support tray includes a top surface defining a flat surface. The support tray can include drainage holes formed in a top surface for drainage of liquid from the top surface. In some embodiments, the support tray can include a raised edge along perimeter walls of the support tray. The raised edge extends vertically above a plane defined by a top surface of the support tray. In some embodiments, the support tray can include a railing extending from a top surface of the support tray along at least one perimeter wall of the support tray.

In some embodiments, the juicer can include a base mounted to the support tray, a post, a press tray mounted to the post, a connector coupled to a top of the post, a handle pivotably coupled to the connector, and a press cap configured to move up and down relative to the press dray during pivoting of the handle. In some embodiments, the juicer can include a handle pivotably coupled to the juicer. The handle can include a groove formed therein. In such embodiments, the assembly can include an elastic strap connected at a first end to the support tray and including a loop at an opposing second end. The loop can be configured to engage with the groove formed in the handle to lock the handle in a downward position.

In some embodiments, at least a portion of the support tray can be magnetized. The support assembly can include mounting flanges coupled at one end to a first end of a vertical support tube. The support assembly includes a horizontal support tube coupled to a second end of the vertical support tube. The mounting flanges can include radially spaced holes and the vertical support tube can include a hole corresponding with at least one of the radially spaced holes. The mounting flanges can be spaced to receive at least a portion of the mounting tube therebetween. The radially spaced holes of the mounting flanges can be configured to align with the hole of the vertical support tube, and further configured to receive a release mechanism therethrough for coupling of the mounting flanges to the vertical support tube. the mounting flanges and the vertical support can define a first adjustment mechanism configured to vary an angle between the mounting flanges and the vertical support tube. A joint between the vertical support tube and the horizontal support tube can include an adjustment mechanism configured to vary an angle between the vertical support tube and the horizontal support tube.

In some embodiments, the juicer assembly can include a balancing feature disposed at a front face of the vertical support tube. The balancing feature can include a flat bottom surface substantially aligned with a bottom surface of the horizontal support tube. The support assembly can include multiple holes configured to engage with an attachment mechanism of the hitch. The multiple holes provide variability in a distance of the support tray relative to the vehicle.

The support tray can include multiple slots formed along a perimeter of the support tray configured to receive complementary extensions of one or more accessories for detachably securing the one or more accessories to the support tray. The support tray can include spaced slots formed along at least along a portion of a perimeter of the support tray configured to receive complementary hanging features of one or more accessories for detachably securing the one or more accessories to the support tray.

In accordance with embodiments of the present disclosure, an exemplary support tray assembly attachable to a hitch of a vehicle is provided. The assembly includes a support tray, and a support assembly coupled to the support tray. One end of the support assembly is configured to engage with a hitch of a vehicle for mounting of the support tray assembly to the hitch.

In accordance with embodiments of the present disclosure, an exemplary support tray assembly is provided. The assembly includes a support tray defining a substantially flat top surface, a raised edge or railing extending from at least some perimeter edges of the top surface of the support tray, and one or more drainage holes formed in the support tray.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the juicer assembly, reference is made to the accompanying figures, wherein:

FIG. 1 is a right side view of an exemplary juicer assembly in accordance with embodiments of the present disclosure detachably coupled to a car hitch;

FIG. 2 is a front view of an exemplary juicer assembly of FIG. 1;

FIG. 3 is a rear view of an exemplary juicer assembly of FIG. 1;

FIG. 4 is a detailed perspective view of an exemplary juicer assembly of FIG. 1;

FIG. 5 is a detailed side view of an exemplary juicer assembly of FIG. 1;

FIG. 6 is a detailed side view of an exemplary juicer assembly of FIG. 1;

FIG. 7 is a detailed front view of an exemplary juicer assembly of FIG. 1;

FIG. 8 is a detailed bottom view of an exemplary juicer assembly of FIG. 1;

FIG. 9 is a perspective view of a support tray and accessory of an exemplary juicer assembly of FIG. 1;

FIG. 10 is a top view of an exemplary juicer assembly in accordance with embodiments of the present disclosure detachably coupled to a car hitch;

FIG. 11 is a front view of an exemplary juicer assembly of FIG. 10;

FIG. 12 is a side view of an exemplary juicer assembly of FIG. 10;

FIG. 13 is a detailed top view of an exemplary juicer assembly of FIG. 10;

FIG. 14 is a bottom view of an exemplary juicer assembly of FIG. 10;

FIG. 15 is a detailed view of an exemplary juicer assembly of FIG. 10;

FIG. 16 is a perspective view of accessories for an exemplary juicer assembly of FIG. 10;

FIG. 17 is a perspective view of accessories releasably coupled to an exemplary juicer assembly of FIG. 10;

FIG. 18 is a detailed side view of a tilt adjustment assembly of an exemplary juicer assembly of FIG. 10;

FIG. 19 is a perspective view of an exemplary juicer assembly of FIG. 10 during use of a tilt adjustment assembly;

FIG. 20 is a bottom view of an exemplary juicer assembly in accordance with embodiments of the present disclosure including a bottom support system in a stored configuration and a juicer detached from a bottom of a support tray;

FIG. 21 is a bottom view of an exemplary juicer assembly of FIG. 20 including a bottom support system in a deployed configuration; and

FIG. 22 is a top view of an exemplary juicer assembly of FIG. 20.

### DETAILED DESCRIPTION

The terms “slot”, “hole”, and “opening” are used interchangeably herein, and can refer to any type of configuration of an opening in a structure, e.g., slotted, circular, hole, or any other configuration known in the industry.

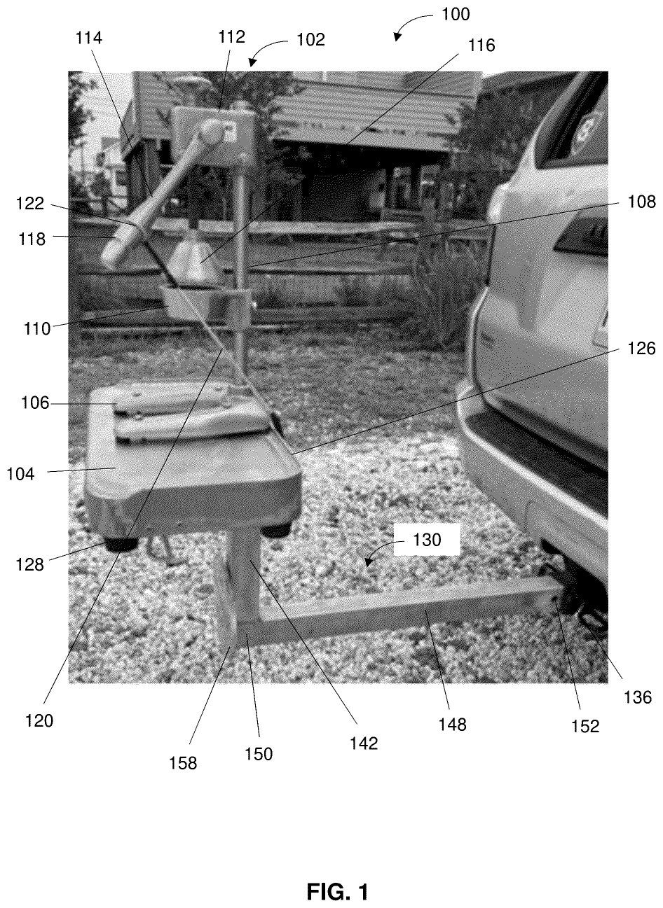

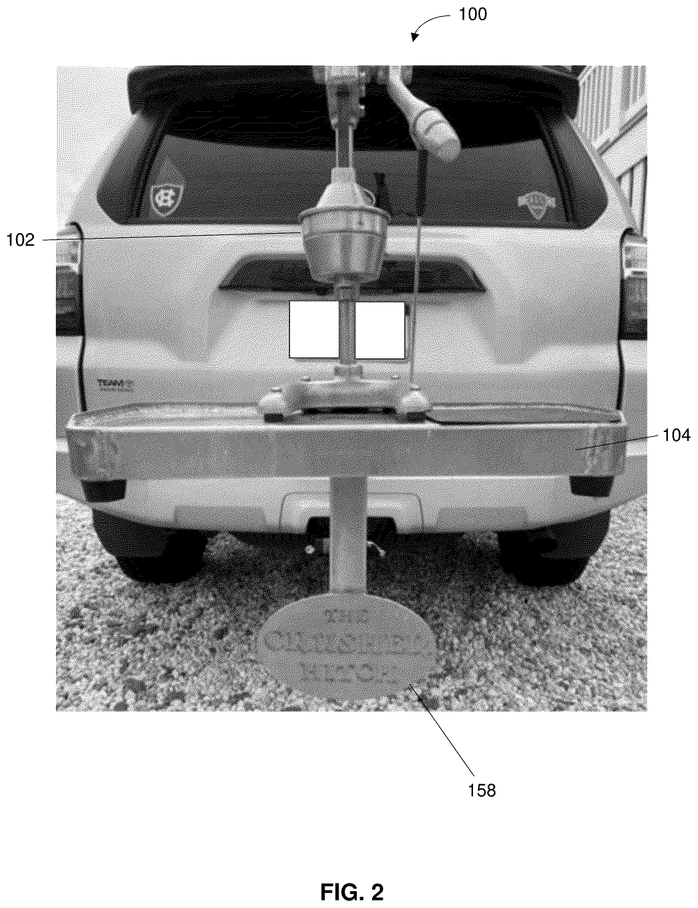

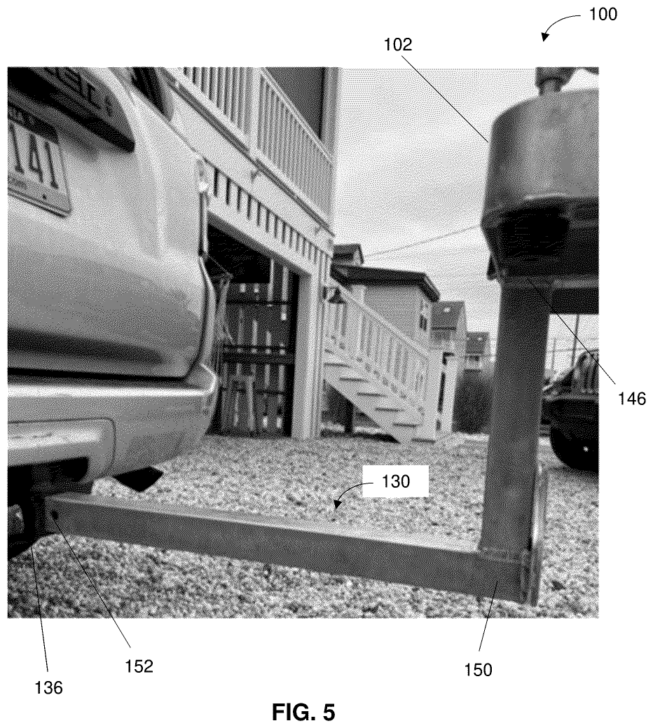

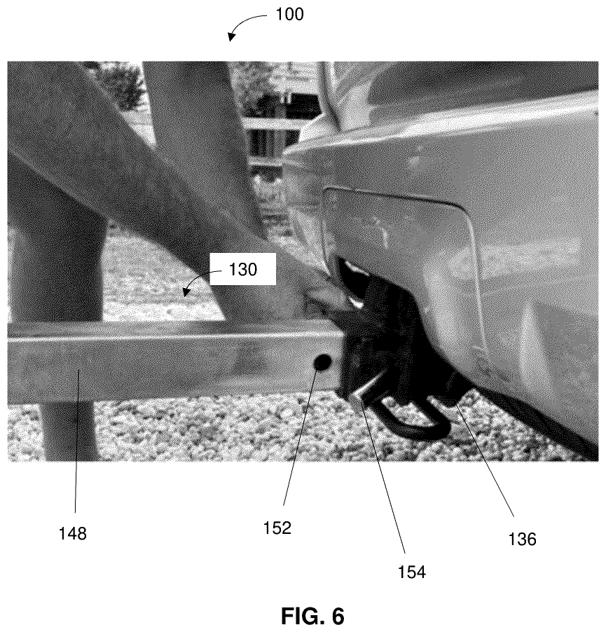

FIGS. 1-9 are various views of an exemplary juicer assembly 100 (hereinafter “assembly 100”). The assembly 100 includes a manual citrus juicer 102 coupled to a top surface of a support tray 104 (e.g., table). The juicer 102 generally includes a base 106, a post 108, a press tray 110 mounted to the post 108, a connector 112 coupled to the top of the post 108, a handle 114 pivotably coupled to the connector 112, and a press cap 116 configured to move up and down relative to the press tray 110 during pivoting of the handle 114. The base 106 of the juicer 102 can be bolted to the top surface of the support tray 104 to ensure a rigid and/or tight connection between the juicer 102 and the support tray 104. In some embodiments, the base 106 can be formed as part of the support tray 104 such that the juicer 102 is not removable from the support tray 104. The handle 114 can include one or more circumferential notches or grooves 118 formed therein (see FIG. 1). An elastic strap 120 can be connected to a rear edge of the support tray 104 at one end and the opposing end includes a flexible loop 122 configured to engage with the groove 118 to secure and lock the handle 114 in the lowest position. The elastic strap 120 can be used to lock the handle 114 in place during transport of the assembly 100.

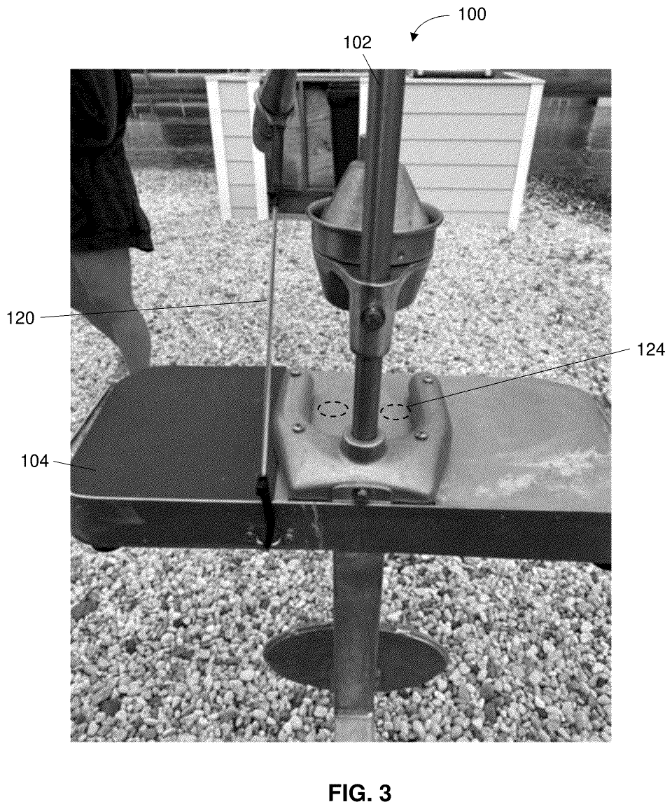

The support tray 104 defines a substantially flat platform on which fruit, utensils and/or accessories can be positioned during use of the juicer 102. Although the top surface of the support tray 104 is illustrated as having a planar, solid surface, in some embodiments, the support tray 104 can include multiple openings 124 formed therein to allow for drainage of liquids (see, e.g., FIG. 3). In some embodiments, the openings 124 can be formed only under the juicer 102, e.g., between the base 106 legs. In some embodiments, the openings 124 can be formed along the entire top surface of the support tray 104. In some embodiments, the openings 124 can include removable plugs to allow for selective and/or regulated drainage of liquid from the top surface. In some embodiments, the support tray 104 can include a removable drip pan (not shown) positioned under the top surface 104 and configured to catch any liquid draining through the openings 124. The drip pan can be removed (by sliding out from the frontmost edge of the juicer 102) and emptied before being repositioned under the top surface. In some embodiments, the top surface of the support tray 104 can be angled to guide drainage of liquid in a specific direction (e.g., towards the rear edge of the support tray 104).

The rear and side perimeter edges of the support tray 104 can include a raised lip or edge 126 that extends vertically above a plane defined by the top surface of the support tray 104. In some embodiments, the raised edge 126 can extend along the entire perimeter of the support tray 104. The raised edge 126 prevents items from rolling off of the support tray 104 during use, and can assist with guiding drainage of liquid from the top surface. In some embodiments, the bottom surface of the support tray 104 can include rubber feet 128 mounted at each respective corner to allow for use of the support tray 104 and juicer 102 when detached from a support assembly 130 (discussed below).

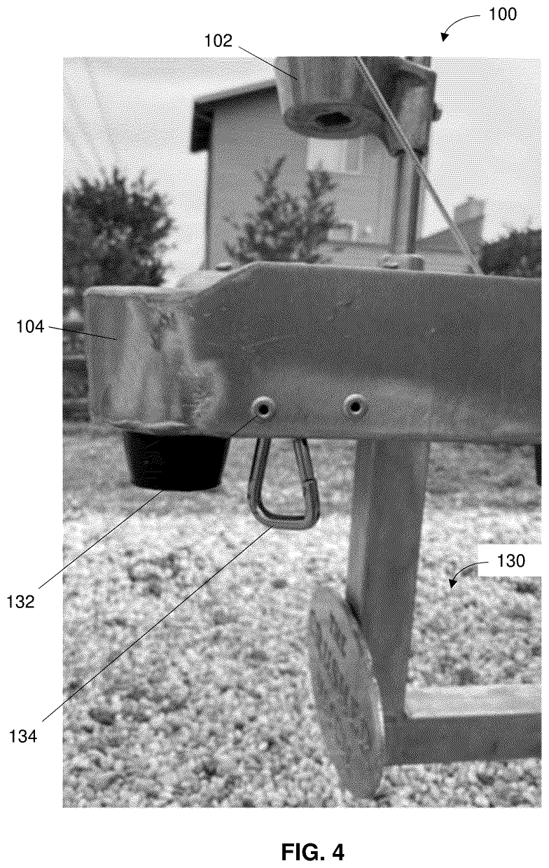

The support tray 104 can include a variety of features to assist with use of the juicer 102 and/or to support accessories. In some embodiments, the support tray 104 can include multiple bars or hooks 132 coupled to and extending from an inner side surface (see, e.g., FIG. 4). The hooks 132 can receive clips 134 for hanging of accessories on the sides of the support tray 104. The hooks 132 and/or clips 134 can be used to hang, e.g., ice, fruit, garbage, or the like. In some embodiments, the side edges of the support tray 104 can include slots formed therein (not shown) configured to engage with complementary extensions of an ice tray or other accessories. In some embodiments, one or more sections of the support tray 104 (e.g., side edges, or the like) can be magnetized to hold metal objects, e.g., utensils, knives, knife sheath, or the like.

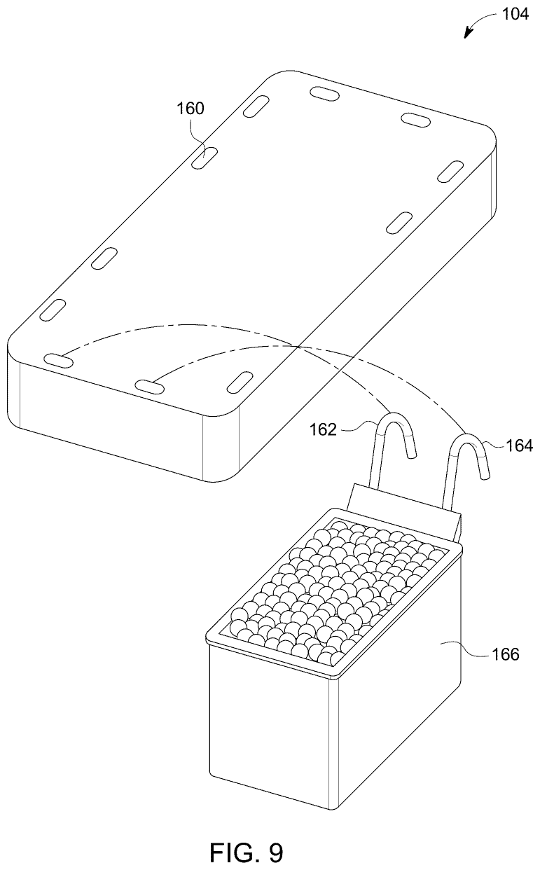

In some embodiments, the support tray 104 can include multiple slots 160 formed in the top surface of the support tray 104 along the perimeter. (See, e.g., FIG. 9). The slots 160 can be spaced from each other at a predetermined distance and designed to receive similarly spaced extensions and/or hooks 162, 164 of an accessory 166 such that the accessory 166 can be removably attached to the support tray 104. Although referred to as hooks 162, 164, it should be understood that any configuration of the extensions can be used to hold the accessory 166 in place, e.g., holders, a securing mechanism, a clip, a fastener, combinations thereof, or the like. The accessory 166 can be any accessory associated with outdoor tailgating such as, e.g., an ice bucket, a bottle/cup holder, a cooler, a garbage can, a container for fruits (e.g., oranges, grapefruits, lemons, limes, or the like), and combinations thereof, or the like. Multiple accessories 166 could be attached at multiple slot 160 locations along the support tray 104 at the same time depending on the needs of the user. The slots 160 and hooks 162, 164 are preferably universal in size to allow any accessory 166 with hooks to be received in the slots 160.

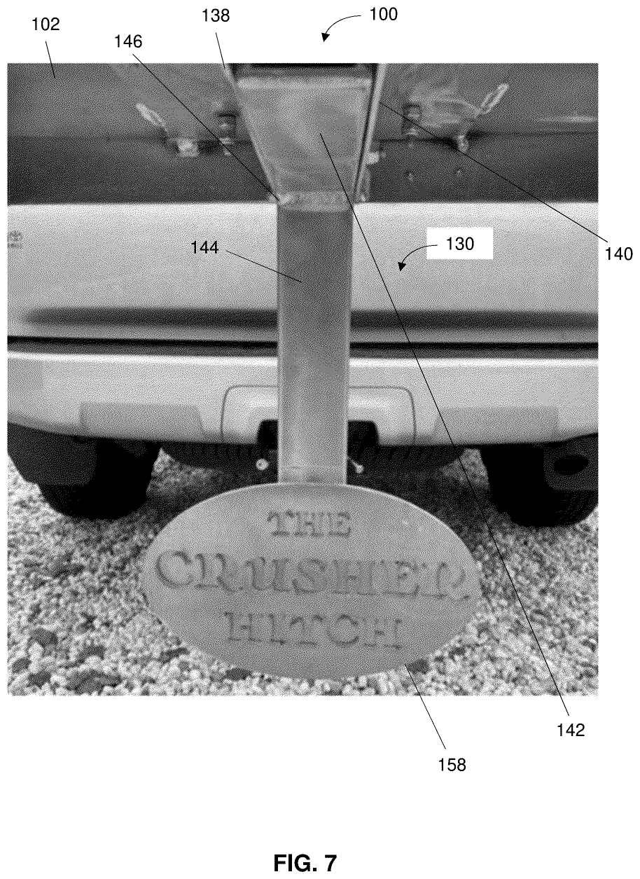

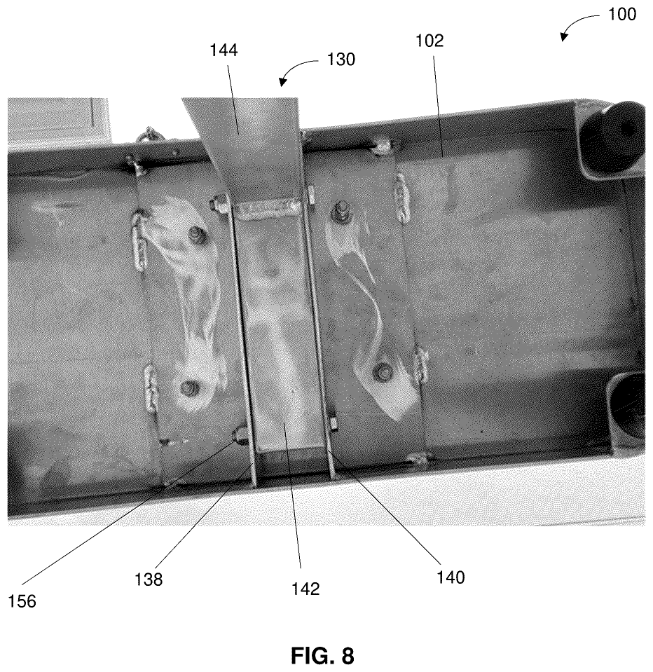

The support tray 104 is detachably mounted to the support assembly 130 which, in turn, is configured to be detachably secured to a hitch 136 of a vehicle (both rear or front). In some embodiments, the support tray 104 can be fixedly secured to the support assembly 130. As illustrated in FIGS. 7 and 8, the bottom surface of the support tray 104 includes two mounting flanges 138, 140 extending perpendicularly therefrom. The flanges 138, 140 are spaced from each other to create slot configured and dimensioned to receive a mounting tube 142 of the support assembly 130. Specifically, the support assembly 130 includes the mounting tube 142 coupled at one end to a vertical support tube 144 at joint 146, and the vertical support tube 144 is coupled at the opposing end to a horizontal support tube 148 at joint 150. The mounting tube 142 extends substantially perpendicularly from the vertical support tube 144, and the horizontal support tube 148 extends substantially perpendicularly from the vertical support tube 144, with the mounting tube 142 extending parallel to the horizontal support tube 148. The opposing end of the horizontal support tube 148 includes holes 152 configured to align with holes in the hitch 136 and engage with an attachment mechanism 154 to secure the tube 148 to the hitch 136. In some embodiments, the support assembly 130 can include a vertical tube that allows the juicer assembly 100 to be secured to a boat, e.g., to fit into a fishing rod holder, or the like. In some embodiments, the support assembly 130 can be removable from the support tray 104 such that the support tray 104 can be positioned on a countertop for use away from a vehicle. In some embodiments, the support tray 104 can be provided without the support assembly 130, and configured to simply sit on a surface, such as a countertop. In such embodiments, the support tray 104 can include fold out legs under the support tray 104. In some embodiments, the juicer assembly 100 can include fold out legs that allow the support tray 104 to be used away from the vehicle in any environment. In some embodiments, the juicer assembly 100 can include legs that allow the support tray 104 to be used away from the vehicle in any environment. In some embodiments, the legs can be, e.g., folded out, screwed into complementary threaded holes at the bottom of the support tray 104, connected via spring-loaded snap buttons and complementary holes at the bottom of the support tray 104, or the like. In such embodiments, the support tray 104 can include a removable drainage tray underneath the support tray 104 which can slide out from the support tray 104.

With reference to FIG. 8, the mounting tube 142 includes sets of holes that align with complementary holes in the mounting flanges 138, 140 during assembly. Bolts 156 can be passed through the respective holes of the mounting flanges 138, 140 and the mounting tube 142 to secure the support assembly 130 to the bottom of the support tray 104. Although the joints 146, 150 of the support assembly 130 are illustrated as rigid, in some embodiments, each of the joints 146, 150 can include an adjustment mechanism (not shown) that allows the respective tubes to pivot relative to each other. The adjustment mechanism allows for customization of the angle of the respective tubes relative to each other, allowing the user to level the table when the vehicle is parked in an uneven location and/or angle the table for improved drainage. For example, the joint 146 can include an adjustment mechanism that allows for pivoting of the mounting tube 142 relative to the vertical support tube 144 in a first direction, and the joint 150 can include an adjustment mechanism that allows for pivoting of the vertical support tube 144 relative to the horizontal support tube 148 in a second direction. The first and second directions can be substantially perpendicular to each other. In some embodiments, the adjustment mechanism can include a plate with multiple holes associated with different angles, and a spring-loaded pin configured to engage with one of the holes. The pin can be depressed and the joint angle can be adjusted along the plate. When the desired angle is achieved, the pin can be released to engage with the appropriate hole to lock the joint in position.

The holes 152 and the attachment mechanism 154 in the horizontal support tube 148 are provided to allow the user to adjust the distance of the support tray 104 relative to the rear trunk and/or bumper of the vehicle. Depending on the desired distance of the support tray 104 relative to the rear of the vehicle, the appropriate hole 152 can be selected. Adjustment of this distance allows the assembly 100 to be positioned far enough away to allow the trunk of the vehicle to be opened without interference from the assembly 100. Vehicles with trailer hitches have different styles of rear gates, such as a dropping rear tail gate (e.g., pick-up truck), a rising rear lift gate (e.g., SUV), a swinging rear door gate (e.g., Jeep Wrangler), or the like. As such, the support assembly 130 is adaptably designed to fit any type of vehicle with a trailer hitch in such a way as to allow free movement (i.e., opening and closing) of any style rear gate of a vehicle. The support assembly 130 can be configured for attachment to any type of trailer hitch, such as either the front or rear of the vehicle. In some embodiments, the support assembly 130 can be connected to any receptacle on the vehicle and is not limited to a trailer hitch.

The support assembly 130 can optionally include a balancing feature 158 secured to the front-facing surface of the vertical support tube 144 and/or the front-facing surface of the horizontal support tube 148. In some embodiments, the front face of the balancing feature 158 can function as a sign and can include text, images, and/or decals. Although the balancing feature 158 is illustrated with a rounded bottom surface, in some embodiments, the balancing feature 158 can define a flat bottom surface that substantially aligns with the bottom of the horizontal support tube 148. When the assembly 100 is detached from the hitch 136, the flat bottom surface of the balancing feature 158 can prevent the assembly 100 from rotating and falling over when positioned on the ground. The assembly 100 therefore includes various features that provide convenient transport and use of the juicer in any location.

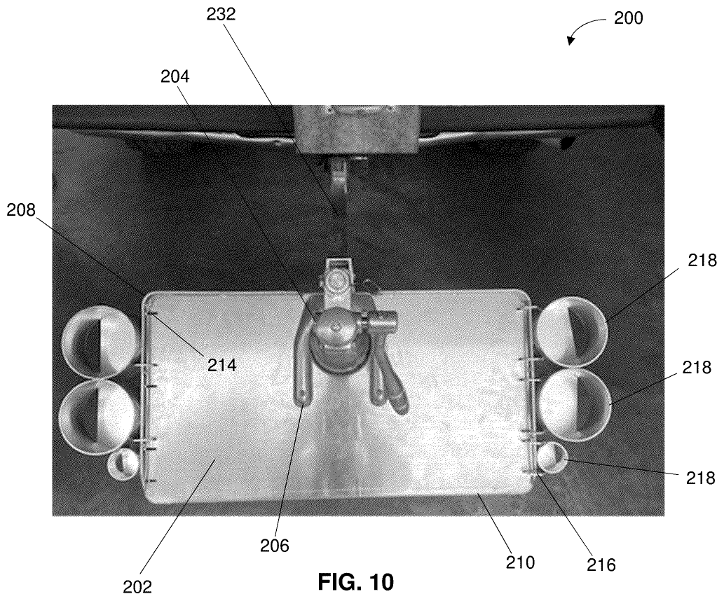

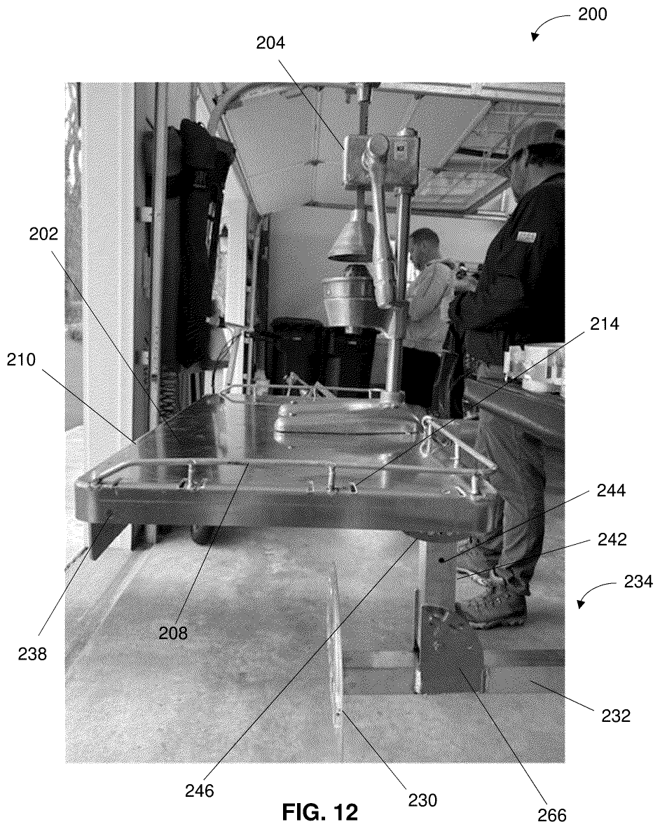

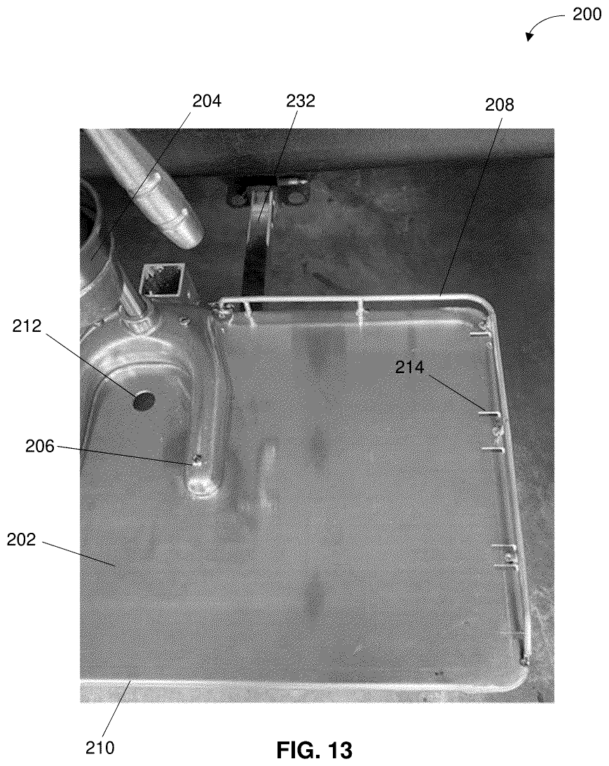

FIGS. 10-19 illustrate various views of an exemplary juicer assembly 200. The juicer assembly 200 can be substantially similar to the juicer assembly 100, except for the distinctions noted herein. The support tray 202 of the juicer assembly 200 receives the juicer 204 with a base 206 which can be bolted to the top surface of the support tray 202. In some embodiments, the base 206 can be welded to the top surface of the support tray 202 for a permanent connection. In some embodiments, the base 206 can be formed as a single structure with the support tray 202 for a permanent connection.

In some embodiments, rather than (or in addition to) the raised perimeter edge, the support tray 202 can include a raised railing 208 that extends perpendicularly from the top surface along the side and rear perimeter edges. The railing 208 prevents items, such as fruit or accessories, from falling off of the side of the support tray 202. In some embodiments, the frontmost edge 210 of the support tray 202 can remain clear of the raised edge and/or the railing. In some embodiments, the frontmost edge 210 can also include the raised edge and/or railing. In some embodiments, the support tray 202 can include one or more drainage holes 212 extending therethrough. Although illustrated as located between the legs of the base 206 of the juicer 204, it should be understood that that drainage holes 212 can be formed throughout the surface area of the support tray 202 to provide for drainage from the support tray 202.

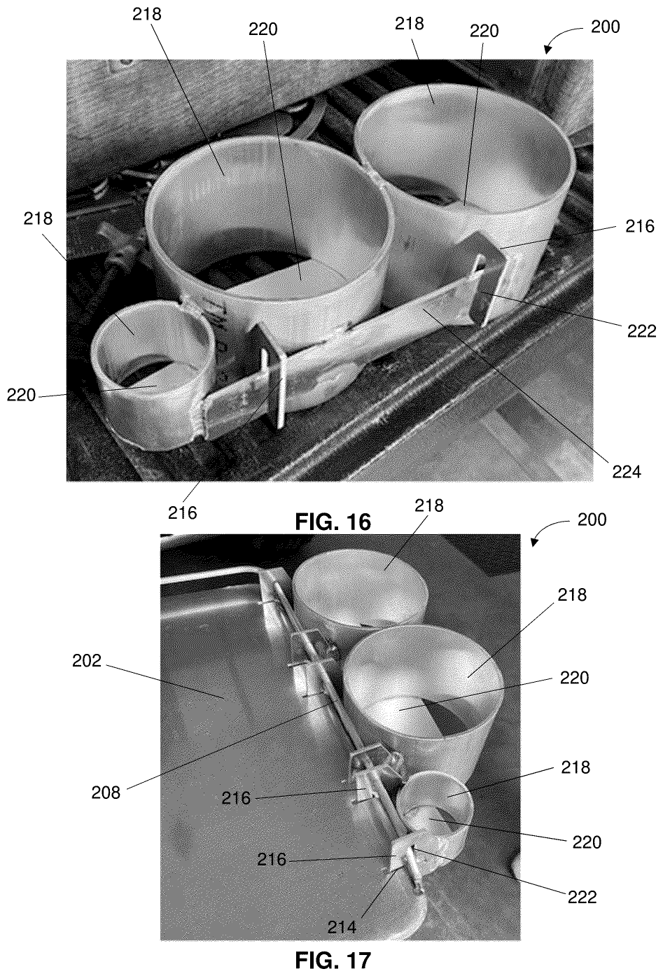

In some embodiments, the support tray 202 can include spaced slots 214 formed along the side and/or rear perimeter edges. The slots 214 can be located offset from the side and/or rear perimeter edges, and can extend perpendicularly from the respective side and/or perimeter edges. The slots 214 are formed in pairs and are configured to receive hanging features 216 associated with accessories 218 (e.g., supports, holders, or the like) capable of being removably attached to the support tray 202. For example, as illustrated in FIGS. 16-17, the accessories 218 can be in the form of cylindrical bodies each having a bottom support 220 extending across at least a portion of the bottom of the cylindrical bodies. The bottom support 220 can leave a portion of the bottom of the cylindrical bodies exposed (e.g., bottom openings) to allow for drainage of liquid from the accessories 218. The diameter of the accessories 218 can vary to allow for use of different items with the accessories 218. For example, the diameters can vary to allow for support of bottles, cups, ice, or the like. In some embodiments, the accessories 218 can be of various shapes, e.g., cylindrical, square, rectangular, or the like, to accommodate various items.

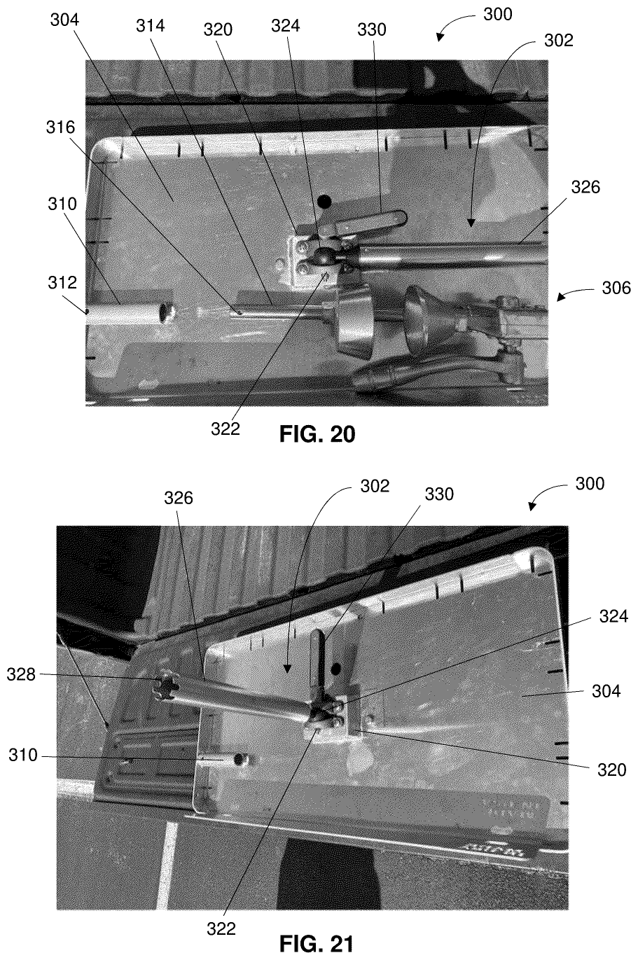

Each accessory 218 can include a pair of hanging features 216. Each hanging feature 216 can be in the form of an L-shaped extension protruding from the side wall of the accessory 218, with a vertical slot 222 formed between the vertical component of the hanging feature 216 and the side wall of the accessory 218. In some embodiments, multiple accessories 218 can be coupled together with a join plate 224 such that the entire assembly of accessories 218 can be attached and detached from the support plate 202 (see, e.g., FIG. 16). In some embodiments, the accessories 218 can each be independently attached and detached relative to the support plate 202. The vertical slot 222 of the hanging features 216 is configured to fit over the railing 208 and the bottom ends of the hanging features are configured to fit at least partially into the slots 214 formed in the support tray 202 (sec, e.g., FIG. 20). In combination, the railing 208 and slots 214 maintain the position of the accessories 218 in place relative to the support tray 202. In some embodiments, the spacing of the slots 214 can be standardized such that any accessory 218 of any size can be positioned along the side and/or rear edges of the support tray 202. In some embodiments, the slots 214 can also act as drain holes for the tray support 202.

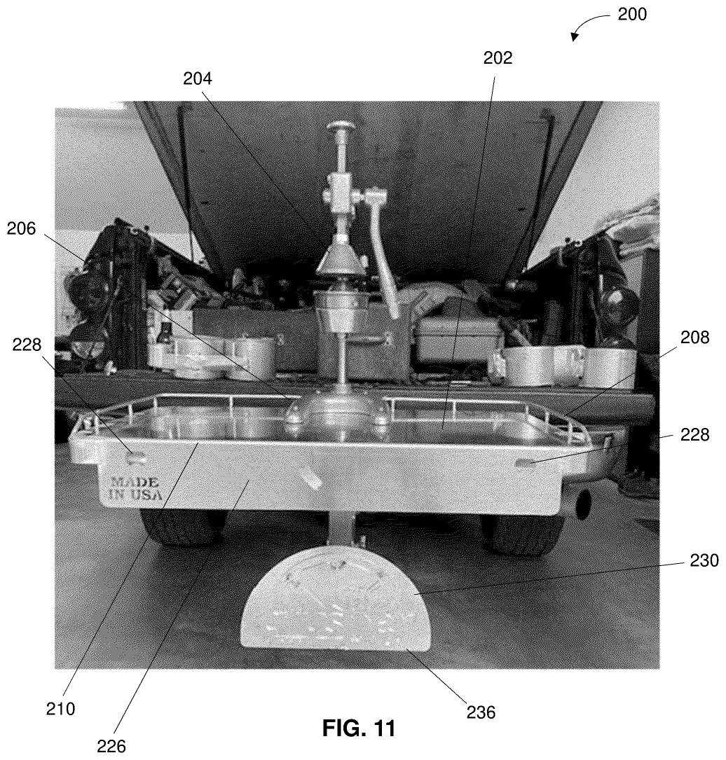

In some embodiments, the support tray 202 can include a front plate 226 extending perpendicularly downward from the top surface of the support tray 202. In some embodiments, the front plate 226 can include one or more cutouts 228 formed therein that function as bottle openers (see, e.g., FIG. 11). In some embodiments, the cutouts 228 can be personalized into any configuration (not limited to bottle openers), e.g., a name or logo. In some embodiments, the cutouts 228 can be formed by laser cutting. The balancing feature 230 extending from the support tube 232 of the support assembly 234 can include a substantially flat bottom edge 236. The flat bottom edge 236 ensures that that juicer assembly 200 will not roll over when removed from the hitch and positioned on the ground. In some embodiments, one or more side plates extending from the side edges of the support tray 202 can include holes 238 configured to removably receive a clip capable of supporting accessories for use with the juicer assembly 200 in a hanging manner. Thus, clips can be used to hang one more items to the support tray 202 for convenient access during use of the juicer assembly 200.

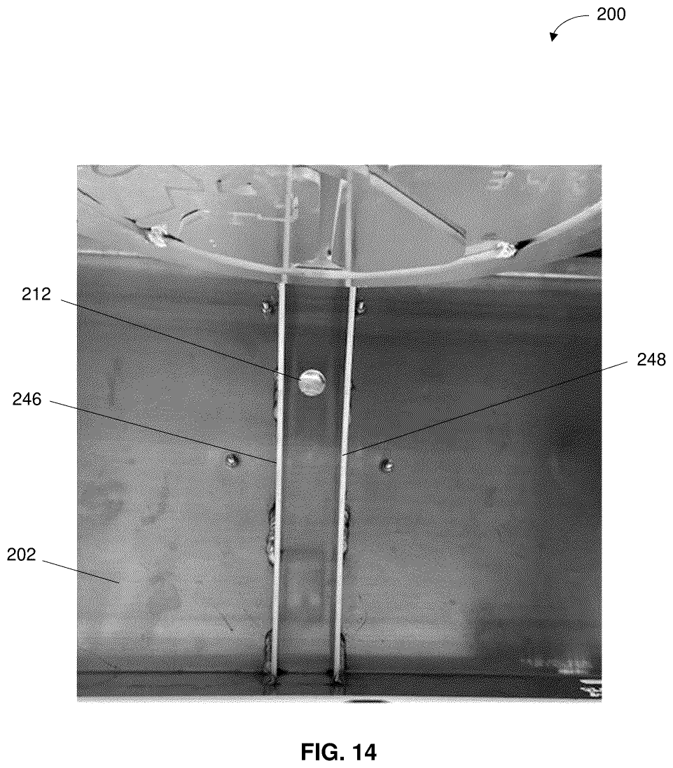

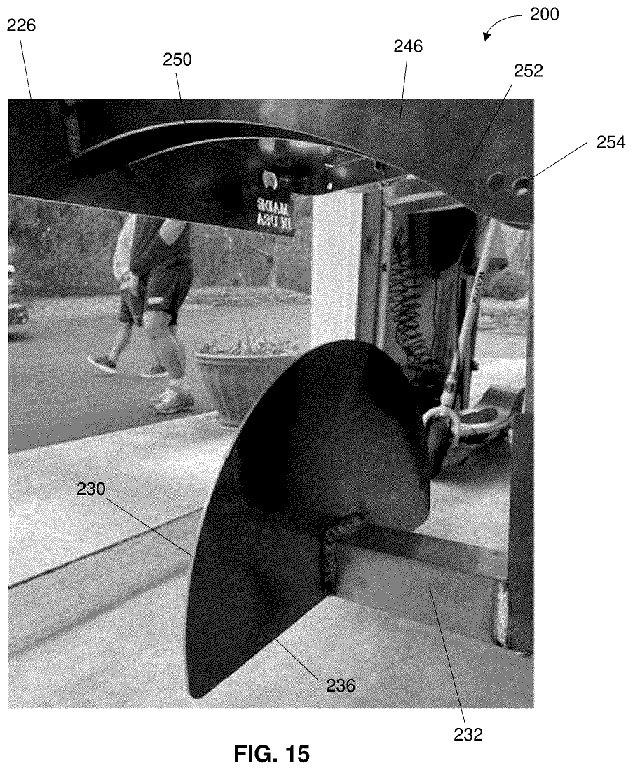

The support assembly 234 includes the horizontal support tube 232 that extends up to the balancing feature 230, and a vertical support tube 242 extending from the horizontal support tube 232. In some embodiments, the support tube 242 can also include one or more holes 244 capable of receiving a clip for supporting accessories for use with the juicer assembly 200. The support assembly 234 includes features that allow for pivoting of the support tray 202 relative to the vertical support tube 242, and for pivoting of the vertical support tube 242 relative to the horizontal support tube 232. In particular, the juicer assembly 200 includes two spaced mounting flanges 246, 248 coupled or welded to the bottom surface of the support tray 202, and extending from the rear to the front of the support tray 202 (see, e.g., FIG. 14). The mounting flanges 246, 248 can define a curving or wave-like bottom edge 250, 252 that ensures sufficient structural support is provided to the bottom surface of the support tray 202 (see, e.g., FIG. 15).

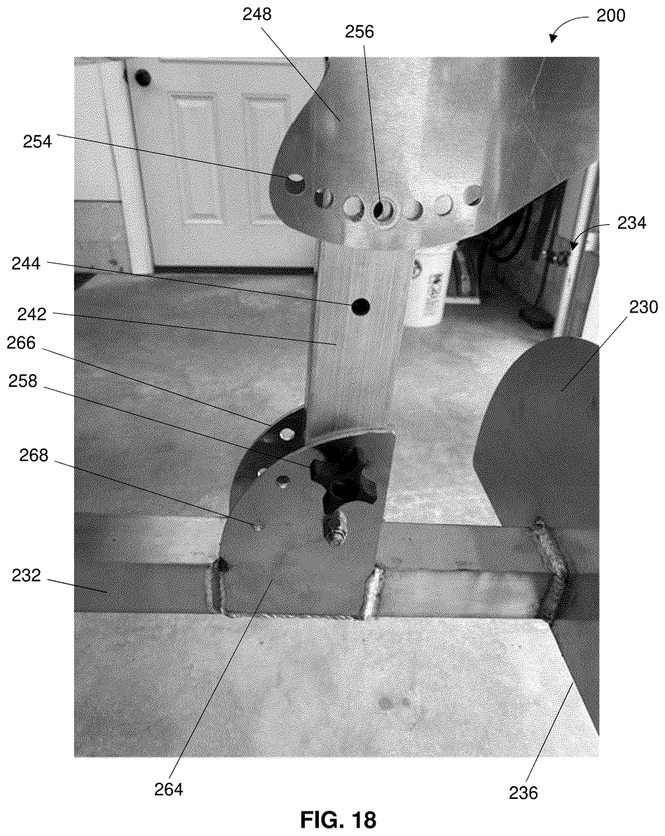

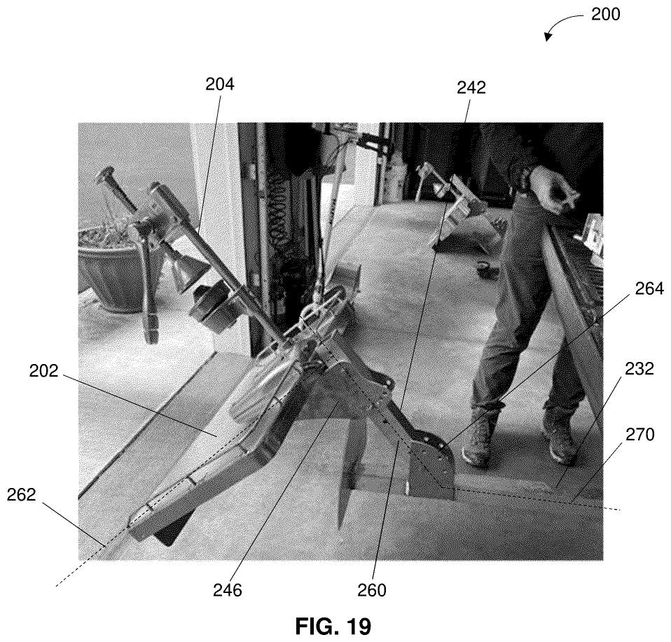

The proximal end of the flanges 246, 248 couples to the front plate 226, and the distal end includes radially spaced holes 254 that correspond with a hole 256 formed in the vertical support tube 242 (see, e.g., FIG. 18). A quick-release mechanism (similar to quick-release mechanism 258) can be used to selectively pivot the flanges 246, 248 (and thereby the support tray 202) relative to the vertical support tube 242. This provides a customization of the angle defined between axes 260, 262 (see, e.g., FIG. 19). The horizontal support tube 232 includes flanges 264, 266 extending vertically therefrom. The flanges 264, 266 includes radially spaced holes 268 that correspond with a hole (not visible) formed in the vertical support tube 242 such that the quick-release mechanism 258 can be used to selectively release and engage the flanges 264, 266 into the desired position. This provides a customization of the angle defined between axes 260, 270 (see, e.g., FIG. 19).

The angle adjustment mechanism/assembly therefore allows the support tray 202 to be pivoted frontward or rearward relative to the vertical support tube 246, and also allows pivoting of the vertical support tube 246 relative to the horizontal support tube 232. Such pivoting can be used to temporarily move the support tray 202 out of the way when opening a rear or trunk door of the vehicle, or can be used to pivot the entire juicer assembly 200 into a substantially flat configuration for storage, shipping and/or transport. In some embodiments, the angle adjustment mechanism/assembly can include a pivoting ability at the support tube connecting to the hitch of the vehicle, such that the entire assembly can be pivoted to the right or left to allow for opening of the rear door of the vehicle. In some embodiments, rather than sitting on the support tray 202, the juicer can extend directly from the top of the vertical support tube 246 with the juicer hanging or being positioned over the support tray 202.

FIGS. 20-22 show another exemplary juicer assembly 300 including a bottom support system 302 that allows the assembly 300 to be detachably mounted/secured to complementary structures. For example, the bottom support system 302 can be used to detachably secure the support tray 304 to, e.g., a complementary pipe extending from a trailer hitch, a fishing rod holder or opening on a boat, or the like. The assembly 300 further allows the juicer 306 to be detached from the base 308 and stored underneath the support tray 304 for transport and/or storage.

The bottom of the support tray 304 can include an attachment element 310 in the form of a cylindrical, hollow pipe. The distal end of the attachment element 310 includes a hole 312 formed therein and extending into the hollow interior of the element 310. The juicer 302 includes a rod or extension 314 protruding from the bottom of the press tray. The diameter of the extension 314 is dimensioned complementary to the interior of the attachment element 310 such that the extension 314 can be at least partially inserted into the attachment element 310. The distal end of the extension 314 can include a hole 316 formed therein complementary to the hole 312 of the attachment element 310.

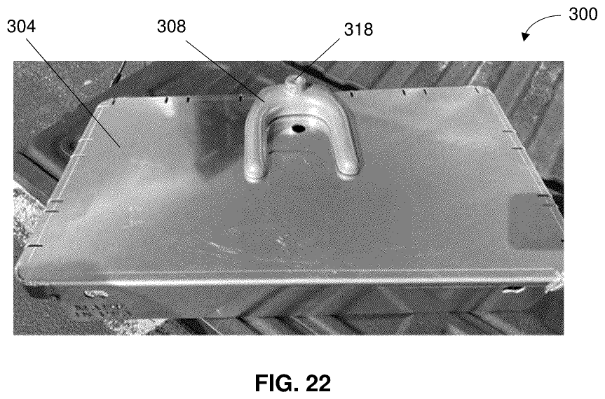

When the extension 314 is inserted into the attachment element 310, the holes 312, 316 can align such that a fastener can be passed through hole 312 and engaged with hole 316 to maintain the positioned of the juicer 306 relative to the attachment element 310. In some embodiments, rather than a hole 316, a set screw can be passed through hole 312 to maintain the position of the juicer 306. The juicer 306 can thereby be stored under the support tray 304 when not in use. As shown in FIG. 22, the base 308 includes an opening 318 configured to receive the end of the extension 314. A set screw can be used to lock the extension 314 relative to the base 308, thereby allowing the juicer 306 to be installed on the top surface of the support tray 304 for use.

The bottom support system 302 can include a base element 320 fixedly mounted to the bottom of the support tray 304. The system 302 includes two spaced side supports 322 positioned around a bearing or ball 324 which is rotatably positioned between the supports 322. The ball 324 is fixedly coupled to the end of a rod or tube 326 which, in some embodiments, can include a hollow interior 328. The system 302 includes a handle 330 which can be used to adjust the distance between the supports 322, thereby locking or releasing the rotation ability of the ball 324.

The tube 326 can thereby be positioned in a stored configuration substantially against the bottom of the support tray 304 when not in use or for shipping purposes, or can be deployed into an extended position (as shown in FIG. 21). The angle of the tube 326 relative to the bottom of the support tray 304 can be adjusted as need based on the intended use, and the handle 330 can be used to tighten or lock the position of the ball 324 (thereby locking the position of the tube 326). In the extended position, the end of the tube 326 can be engaged with a complementary structure, such as an extension from a trailer hitch or a fishing rod holder on a boat. The system 302 allows the juicer 306 to be used in a variety of settings, including on a countertop or tabletop, with a trailer hitch, on a boat, and other similar settings.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A juicer assembly, comprising:
a support tray;
a juicer on the support tray; and
a support assembly coupled to the support tray, one end of the support assembly is configured to engage with a structure for mounting of the juicer assembly to the structure.

2. The juicer assembly of claim 1, herein the structure includes a hitch for a vehicle and the support assembly is configured to engage with the hitch for mounting of the juicer assembly to the hitch.

3. The juicer assembly of claim 1, wherein the support tray includes drainage holes formed in a top surface for drainage of liquid from the top surface.

4. The juicer assembly of claim 1, wherein the support tray includes a raised edge along perimeter walls of the support tray, the raised edge extending vertically above a plane defined by a top surface of the support tray.

5. The juicer assembly of claim 1, wherein the support tray includes a railing extending from a top surface of the support tray along at least one perimeter wall of the support tray.

6. The juicer assembly of claim 1, wherein the juicer includes a base mounted to the support tray, a post, a press tray mounted to the post, a connector coupled to a top of the post, a handle pivotably coupled to the connector, and a press cap configured to move up and down relative to the press dray during pivoting of the handle.

7. The juicer assembly of claim 1, wherein the juicer includes a handle pivotably coupled to the juicer, the handle including a groove formed therein.

8. The juicer assembly of claim 6, comprising an elastic strap connected at a first end to the support tray and including a loop at an opposing second end, wherein the loop is configured to engage with the groove formed in the handle to lock the handle in a downward position.

9. The juicer assembly of claim 1, wherein at least a portion of the support tray is magnetized.

10. The juicer assembly of claim 1, wherein the support assembly includes mounting flanges coupled at one end to a first end of a vertical support tube, the support assembly including a horizontal support tube coupled to a second end of the vertical support tube.

11. The juicer assembly of claim 10, wherein the mounting flanges include radially spaced holes and the vertical support tube includes a hole corresponding with at least one of the radially spaced holes.

12. The juicer assembly of claim 11, wherein the mounting flanges are spaced to receive at least a portion of the mounting tube therebetween.

13. The juicer assembly of claim 12, wherein the radially spaced holes of the mounting flanges are configured to align with the hole of the vertical support tube, and further configured to receive a release mechanism therethrough for coupling of the mounting flanges to the vertical support tube.

14. The juicer assembly of claim 13, wherein the mounting flanges and the vertical support define a first adjustment mechanism configured to vary an angle between the mounting flanges and the vertical support tube.

15. The juicer assembly of claim 11, wherein a joint between the vertical support tube and the horizontal support tube includes an adjustment mechanism configured to vary an angle between the vertical support tube and the horizontal support tube.

16. The juicer assembly of claim 11, comprising a balancing feature disposed at a front face of the vertical support tube, the balancing feature including a flat bottom surface substantially aligned with a bottom surface of the horizontal support tube.

17. The juicer assembly of claim 1, wherein the support assembly includes multiple holes configured to engage with an attachment mechanism of the hitch, the multiple holes providing variability in a distance of the support tray relative to the vehicle.

18. The juicer assembly of claim 1, wherein the support tray includes multiple slots formed along a perimeter of the support tray configured to receive complementary extensions of one or more accessories for detachably securing the one or more accessories to the support tray.

19. The juicer assembly of claim 1, wherein the support tray includes spaced slots formed along at least along a portion of a perimeter of the support tray configured to receive complementary hanging features of one or more accessories for detachably securing the one or more accessories to the support tray.

20. A support tray assembly, comprising:
a support tray defining a substantially flat top surface;
a raised edge or railing extending from at least some perimeter edges of the top surface of the support tray; and
one or more drainage holes formed in the support tray.
